(19) United States
(12) Patent Application Publication
(10) Pub. No.: US 2026/0178046 A1
(43) Pub. Date: Jun. 25, 2026

(54) PATH PLANNING METHOD, POOL CLEANING ROBOT, AND NON-TRANSITORY COMPUTER-READABLE STORAGE MEDIUM

(71) Applicant: SHENZHEN AIPER INTELLIGENT CO., LTD., Shenzhen (CN)

(72) Inventor: Xiantao QIAN, Shenzhen (CN)

(21) Appl. No.: 19/169,094

(22) Filed: Apr. 3, 2025

(30) Foreign Application Priority Data
Dec. 24, 2024 (CN) 2024119077757

(51) Int. Cl. G05D 1/648; E04H 4/16; G05D 1/245; G05D 105/10; G05D 107/00

(52) U.S. Cl. CPC G05D 1/648; E04H 4/1654; G05D 1/245; G05D 2105/10; G05D 2107/29

(57) ABSTRACT

The present disclosure relates to the technical field of robots, and in particular, provides a path planning method, a pool cleaning robot, and a non-transitory computer-readable storage medium. This method includes obtaining first distance information, where the first distance information indicates the first distance between the first side of the pool cleaning robot and the edge of the pool; when the first distance information meets the first condition, controlling the pool cleaning robot at the first location to rotate by a first angle, the first angle enables the sensing signal to reach the edge of the pool; obtaining second distance information, where the second distance information indicates the second distance between the second side of the pool cleaning robot and the edge of the pool; and controlling the pool cleaning robot to travel to the second location while keeping the second distance information meeting the second condition.

### FIELD OF THE INVENTION

The present disclosure relates to the technical field of robots, and in particular, to a path planning method, a pool cleaning robot, and a non-transitory computer-readable storage medium.

### BACKGROUND OF THE INVENTION

At present, the existing pool cleaning robots are mainly suitable for pool environments with regular shapes (such as rectangular and square pools). They can perform reciprocating cleaning by traveling in a straight line along the length and/or width directions of the pool according to the pre-set path planning.

However, when faced with a pool of irregular shape, the cleaning path in which the existing pool cleaning robots travel in a straight line has a low degree of fit with the edges of the pool, resulting in the fact that the dirt and debris in the irregular areas cannot be cleaned up (see FIG. 1 for details), and a comprehensive and complete cleaning coverage cannot be achieved.

### SUMMARY OF THE INVENTION

The present disclosure is proposed in view of the above-mentioned problems. The present disclosure provides a path planning method, a pool cleaning robot, and a non-transitory computer-readable storage medium.

According to one aspect of the present disclosure, it provides a path planning method applied to a pool cleaning robot, which includes obtaining first distance information, wherein the first distance information indicates a first distance between a first side of the pool cleaning robot and an edge of the pool; when the first distance information meets a first condition, controlling the pool cleaning robot at a first location to rotate by a first angle, wherein the first angle enables a sensing signal to reach the edge of the pool; obtaining second distance information, wherein the second distance information indicates a second distance between a second side of the pool cleaning robot and the edge of the pool; and controlling the pool cleaning robot to travel to a second location while keeping the second distance information meeting a second condition.

In addition, the path planning method according to one aspect of the present disclosure, further including: determining preset path information based on contour information of the edge of the pool, cleaning coverage requirement, or size information of the pool cleaning robot, wherein the preset path information comprises at least one of the following: traveling rules, a traveling direction, a path spacing, and a traveling sequence of paths of the pool cleaning robot.

In addition, the path planning method according to one aspect of the present disclosure, wherein the first distance information indicates the first distance between the first side and the edge of the pool in the traveling direction based on the preset path information.

In addition, the path planning method according to one aspect of the present disclosure, wherein a third distance between the first location and the second location in a translation direction perpendicular to the traveling direction meets a third condition.

In addition, the path planning method according to one aspect of the present disclosure, wherein the first condition comprises that the first distance is less than or equal to a first predetermined distance, the second condition comprises that the second distance is within a second predetermined distance range, and the third condition comprises that the third distance is equal to a third predetermined distance or the traveling duration between the second location and the first location reaches a preset duration.

In addition, the path planning method according to one aspect of the present disclosure, wherein the third predetermined distance comprises an integral multiple of the path spacing.

In addition, the path planning method according to one aspect of the present disclosure, further including: controlling the pool cleaning robot at the second location to rotate by a second angle and continue to travel based on the preset path information.

In addition, the path planning method according to one aspect of the present disclosure, wherein the pool cleaning robot has a first sub-sensor unit configured on the first side and at least one second sub-sensor unit configured on the second side, the step of obtaining the first distance information comprises obtaining the first distance information via the first sub-sensor unit, and the step of obtaining the second distance information comprises obtaining the second distance information via the at least one second sub-sensor unit.

In addition, the path planning method according to one aspect of the present disclosure, wherein the first angle comprises a first preset angle value, or the first angle is determined based on sensing result of the second sub-sensor unit.

In addition, the path planning method according to one aspect of the present disclosure, wherein the second angle comprises a second preset angle value, or the second angle is determined based on the traveling direction of the path or based on a yaw angle given by an inertial measurement unit.

According to another aspect of the present disclosure, it provides a pool cleaning robot, which includes: a sensor unit, configured to obtain first distance information and second distance information, the first distance information indicates a first distance between a first side of the pool cleaning robot and an edge of a pool, and the second distance information indicates a second distance between a second side of the pool cleaning robot and the edge of the pool; a control unit, configured to, when the first distance information meets a first condition, control the pool cleaning robot at a first location to rotate by a first angle, wherein the first angle enables at least a sensing signal to reach the edge of the pool; and control the pool cleaning robot to travel to a second location while keeping the second distance information meeting a second condition.

In addition, the pool cleaning robot according to another aspect of the present disclosure, wherein the sensor unit comprises a first sub-sensor unit and at least one second sub-sensor unit, the first sub-sensor unit is configured on the first side, and the at least one second sub-sensor unit is configured on the second side.

In addition, the pool cleaning robot according to another aspect of the present disclosure, wherein the first side comprises a front side, and the second side comprises a left side or a right side.

In addition, the pool cleaning robot according to another aspect of the present disclosure, wherein the control unit determines preset path information based on contour information of the edge of the pool, cleaning coverage requirement, or size information of the pool cleaning robot, wherein the preset path information comprises at least one of the following: traveling rules, a traveling direction, a path spacing, and a traveling sequence of the paths of the pool cleaning robot.

In addition, the pool cleaning robot according to another aspect of the present disclosure, wherein the first distance information indicates the first distance between the first side and the edge of the pool in the traveling direction based on the preset path information.

In addition, the pool cleaning robot according to another aspect of the present disclosure, wherein a third distance between the first location and the second location in a translation direction perpendicular to the traveling direction meets a third condition.

In addition, the pool cleaning robot according to another aspect of the present disclosure, wherein the first condition comprises that the first distance is less than or equal to a first predetermined distance, the second condition comprises that the second distance is within a second predetermined distance range, and the third condition comprises that the third distance is equal to a third predetermined distance or a walking duration between the second location and the first location reaches a preset duration.

In addition, the pool cleaning robot according to another aspect of the present disclosure, wherein the third predetermined distance comprises an integral multiple of the path spacing.

In addition, the pool cleaning robot according to another aspect of the present disclosure, wherein the first angle comprises a first preset angle value, or the first angle is determined based on sensing result of the second sub-sensor unit.

According to yet another aspect of the present disclosure, it provides a non-transitory computer-readable storage medium having computer-readable instructions stored thereon, wherein the computer-readable instructions cause a processor to perform: obtain first distance information, wherein the first distance information indicates a first distance between a first side of a pool cleaning robot and a edge of a pool; when the first distance information meets a first condition, control the pool cleaning robot at a first location to rotate by a first angle, wherein the first angle enables a sensing signal to reach the edge of the pool; obtain second distance information, wherein the second distance information indicates a second distance between the second side and the edge of the pool; and control the pool cleaning robot to travel to a second location while keeping the second distance information meeting a second condition.

As will be described in detail below, the path planning method according to the embodiments of the present disclosure perceives the distance to the edge of the pool by configuring sensors, so as to make the cleaning path match the edge of the pool, thereby improving the cleaning coverage rate and cleaning efficiency.

It should be understood that both the foregoing general description and the following detailed description are exemplary and are intended to provide further explanation of the claimed technology.

### BRIEF DESCRIPTION OF DRAWINGS

By describing the embodiments of the present disclosure in more detail in combination with the accompanying drawings, the above-mentioned and other objects, features and advantages of the present disclosure will become more apparent. The accompanying drawings are used to provide a further understanding of the embodiments of the present disclosure and constitute a part of the specification. Together with the embodiments of the present disclosure, they are used to explain the present disclosure and do not constitute a limitation to the present disclosure. In the accompanying drawings, the same reference numerals usually represent the same components or steps.

FIG. 1 is a scenario schematic diagram illustrating the application scenario of a path planning method according to an embodiment of the present disclosure.

FIGS. 2A and 2B are schematic diagrams illustrating a pool cleaning robot according to an embodiment of the present disclosure.

FIG. 3 is a method flowchart illustrating the path planning method according to an embodiment of the present disclosure.

FIG. 4 is a method flowchart further illustrating the path planning method according to an embodiment of the present disclosure.

FIG. 5 is a path schematic diagram illustrating the path planning method according to an embodiment of the present disclosure.

FIG. 6 is a path schematic diagram further illustrating the path planning method according to an embodiment of the present disclosure.

FIG. 7 is a hardware block diagram illustrating an electronic device according to an embodiment of the present disclosure.

FIG. 8 is a schematic diagram illustrating a non-transitory computer-readable storage medium according to an embodiment of the present disclosure.

### DETAILED DESCRIPTION OF THE INVENTION

In the following, the technical solution in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by the person skilled in the art without creative work belong to the protection scope of this application.

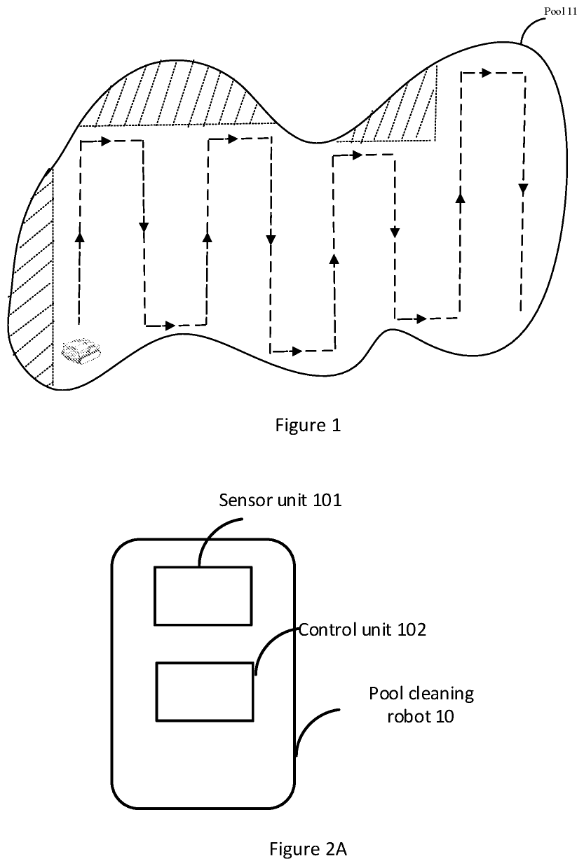

First, an overview of the application scenario according to the embodiments of the present disclosure is provided with reference to FIG. 1.

FIG. 1 is a scenario schematic diagram illustrating the application scenario of the path planning method according to the embodiments of the present disclosure. As shown in FIG. 1, the application scenario may at least include: a pool cleaning robot 10 and a pool 11. The solid black line in the figure represents the shape of the edge of the pool 11, the dashed black line represents the cleaning path of the pool cleaning robot in the prior art, and the shaded area represents the area that the existing pool cleaning robot cannot clean.

Specifically, the pool 11 can be of any shape. It can be either a regular geometric shape or an irregular shape with arcs. There is no specific limitation in this regard, and all such cases are within the scope covered by the present disclosure.

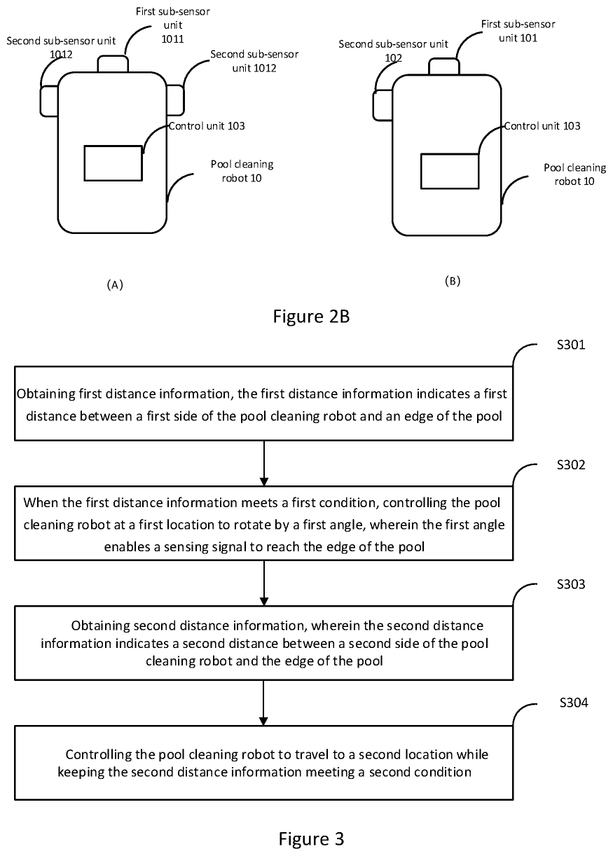

As mentioned above, the existing pool cleaning robots can only clean along straight lines and are not suitable for the irregularly shaped pool 11. This results in cleaning dead zones as shown in the shaded area in FIG. 1. In order to solve this problem, the present disclosure proposes a pool cleaning robot 10. By configuring at least one sensor to perceive the distance between it and the edge of the pool, the cleaning path can be made to conform to the edge of the pool, thereby improving the cleaning coverage rate and cleaning efficiency. Specifically, the pool cleaning robot 10 can be as shown in FIGS. 2A and 2B.

FIGS. 2A and 2B are schematic diagrams illustrating the pool cleaning robot according to the embodiments of the present disclosure. As shown in FIG. 2A, the pool cleaning robot 10 according to the embodiments of the present disclosure may at least include the following components.

The sensor unit 101 is configured to obtain first distance information and second distance information. The first distance information indicates the first distance between the first side of the pool cleaning robot and the edge of the pool, and the second distance information indicates the second distance between the second side of the pool cleaning robot and the edge of the pool. The first side may include the front side of the pool cleaning robot. The second side may include the left side or the right side of the pool cleaning robot, or may include both the left side and the right side simultaneously.

The first distance information and the second distance information can be obtained through a lidar, a camera, or a 3D structured light sensor arranged on the front side, the left side, or the right side of the robot body. For example, the horizontal field of view (FOV) of the lidar is 70-150 degrees, and the lidar located on the front side can perceive both the first distance information and the second distance information.

Specifically, as shown in FIG. 2B, the sensor unit 101 includes a first sub-sensor unit 1011 and at least one second sub-sensor unit 1012. The first sub-sensor unit 1011 is configured on the first side of the pool cleaning robot and is used for obtaining the first distance information. The second sub-sensor unit 1012 is configured on the second side of the pool cleaning robot and is used for obtaining the second distance information.

The control unit 102 is configured to, when the first distance information satisfies the first condition, control the pool cleaning robot at the first location to rotate by a first angle, wherein the first angle enables the sensing signal emitted by at least one second sensor unit to reach the edge of the pool; and under the condition that the second distance information satisfies the second condition, control the pool cleaning robot to travel to the second location.

More specifically, the pool cleaning robot 10 can be as shown in (A) of FIG. 2B. One first sub-sensor unit 1011 is configured on the front side of the robot body, two second sub-sensor units 1012 (respectively configured on the left side and the right side of the body) are provided, and one control unit 102 is included.

It can be understood that during the cleaning process, the second sub-sensor unit 1012 on the left side and the second sub-sensor unit 1012 on the right side can work in coordination. That is to say, in this case, the above-mentioned first angle can be to the left or to the right. Certainly, when both the second sub-sensor unit 1012 on the left side and the second sub-sensor unit 1012 on the right side are available, only one side may operate, that is, the above-mentioned first angle is only to the left or only to the right.

The pool cleaning robot 10 can also be as shown in (B) of FIG. 2B. One first sub-sensor unit 1011 is configured on the front side of the body, one second sub-sensor unit 1012 is configured on the left side or the right side of the body, and one control unit 102 is included.

It should be noted that, as shown in (B) of FIG. 2B, taking the second sub-sensor unit 1012 configured on the left side as an example, the situation where it is configured on the right side is not shown. The principle is the same, and thus will not be elaborated further. It can be understood that, when only the second sub-sensor unit 1012 on the left side is configured, the above-mentioned first angle is only to the right.

In one embodiment of the present disclosure, the first sub-sensor unit 1011 and the second sub-sensor unit 1012 may be ultrasonic sensors, infrared sensors, inertial measurement unit (IMU) sensors, direct time-of-flight (DTOF) sensors, etc.

Among them, the ultrasonic sensor can perform navigation and distance measurement through the positive and inverse piezoelectric effects and information processing based on the characteristics of ultrasonic wave propagation and reflection in water. Specifically, it emits ultrasonic waves, and when the ultrasonic waves propagate in water and encounter an obstacle, an echo will be reflected. After the sensor receives the echo, the built-in circuit can perform digital conversion on the received signal and calculate the distance to the obstacle according to the time-of-flight (TOF) principle.

The infrared sensor can detect the presence of an object and measure the distance by detecting infrared light in water.

The IMU sensor contains components such as an accelerometer, a gyroscope, and a magnetometer. It can measure information such as the acceleration, angular velocity, and magnetic field strength of the robot in three-dimensional space, and then infer information such as the robot's attitude, location, and motion state.

The direct time-of-flight (DTOF) sensor can calculate the distance by emitting a light signal to the target object and measuring the round-trip time of the light signal, for example, by emitting a laser signal. It should be noted that the present disclosure does not specifically limit the type of sensor.

Specifically, the above-mentioned terms such as the first distance information, the second distance information, the first condition, the second condition, the first angle, and the second location will be further described in detail in combination with specific embodiments in FIGS. 3-6.

FIG. 3 is a method flowchart illustrating the path planning method according to the embodiments of the present disclosure. As shown in FIG. 3, the path planning method may at least include the following steps.

In step S301, the first distance information is obtained. The first distance information indicates the first distance between the first side of the pool cleaning robot and the edge of the pool. Here, the first distance information indicates the first distance between the first side and the edge of the pool in the traveling direction based on the preset path information.

As mentioned above, the first side may include the front side of the pool cleaning robot 10. That is to say, the pool cleaning robot 10 travels along the preset path information, and monitors the distance between its front side and the edge of the pool during the traveling process. This distance is recorded as the first distance, and the corresponding information is recorded as the first distance information.

In step S302, when the first distance information satisfies the first condition, the pool cleaning robot at the first location is controlled to rotate by a first angle, wherein the first angle enables the sensing signal to reach the edge of the pool. The first condition includes that the first distance is less than or equal to a first predetermined distance.

Specifically, during the traveling process of the pool cleaning robot 10, when the distance between the front side and the edge of the pool is less than or equal to the first predetermined distance (that is, when the pool cleaning robot 10 reaches the first location), it stops traveling and rotates by the first angle. As mentioned above, the problem to be solved by the present disclosure is that the traveling path of the pool cleaning robot does not conform to the edge of the pool when cleaning an irregular pool. Therefore, the purpose of the rotation here is to enable the sensing signal to reach the edge of the pool. That is to say, after rotating by the first angle, the distance between it and the edge of the pool is monitored to make the traveling path conform to the edge of the pool.

It should be noted that the rotation angle value of the first angle can be a first preset angle value, or it can be determined based on the sensing result of the sensor unit 101 (specifically, it can be the second sub-sensor unit 1012). Specifically, it can be affected by the position of the sensor unit 101 (specifically, it can be the second sub-sensor unit 1012) configured on the pool cleaning robot 10 and the shape of the edge of the pool. That is to say, the first angle can be a fixed value, or it can be dynamically determined according to the hardware devices of the pool cleaning robot 10 and the external environment.

In step S303, the second distance information is obtained via at least one second sensor. The second distance information indicates the second distance between the second side and the edge of the pool.

As mentioned above, the second side may include the left side or the right side of the pool cleaning robot 10. The second distance information is similar to the aforementioned first distance information. Specifically, after the pool cleaning robot 10 rotates, it monitors the distance between its side (i.e., the second side) and the edge of the pool. This distance is recorded as the second distance, and the corresponding information is recorded as the second distance information.

In step S304, while keeping the second distance information meeting the second condition, the pool cleaning robot is controlled to move to the second location. Here, the second condition includes that the second distance falls within a second predetermined distance range.

As described above, after the pool cleaning robot 10 rotates by the first angle, it continues to travel. At this time, its traveling path is no longer determined by the preset path information, but is basically determined by the shape of the edge of the pool. Through the monitoring of the second distance, the pool cleaning robot 10 can travel while maintaining that the second distance between its second side and the edge of the pool meets the second predetermined distance range (that is, to make its traveling path conform to the edge of the pool), until it stops when it reaches the second location.

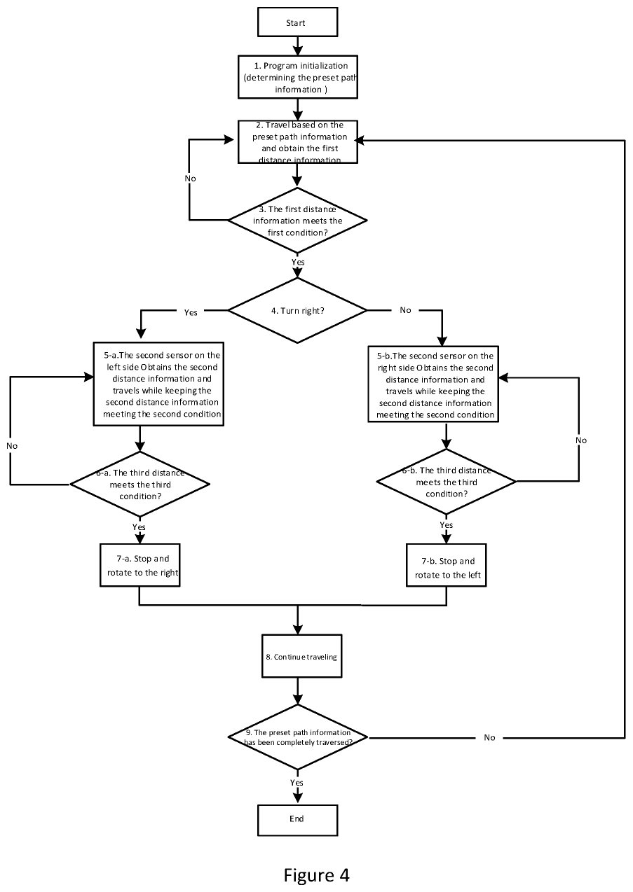

In one embodiment of the present disclosure, the second location can be determined at least by the first location and the third condition. Specifically, the distance between the first location and the second location in the translation direction perpendicular to the traveling direction can be recorded as the third distance. When the third distance satisfies the third condition, it can be considered that the pool cleaning robot 10 has reached the second location. The third condition includes that the third distance is equal to the third predetermined distance or the traveling time between the second location and the first location reaches the preset time. Specifically, a further detailed description will be given with reference to FIGS. 4-6.

FIG. 4 is a method flowchart further illustrating the path planning method according to the embodiments of the present disclosure. As shown in FIG. 4, the method flow of the path planning method according to the embodiments of the present disclosure may at least include the following steps.

1. Program initialization. Specifically, this step includes but is not limited to determining the preset path information based on the contour information of the edge of the pool, the cleaning coverage requirement, or the size information of the pool cleaning robot. The preset path information includes at least one of the following: information such as the traveling rules, traveling direction, path spacing, and traveling sequence of the path of the pool cleaning robot.

In one embodiment of the present disclosure, when the pool cleaning robot 10 has no map, its traveling rules can be: move straight, turn left or right when encountering an obstacle, then turn left or right after traveling a certain distance, and then move straight.

2. Travel based on the preset path information and obtain the first distance information. As mentioned above, after the preset path information is determined in step 1, the pool cleaning robot 10 travels along it. As described in the above-mentioned embodiment, its traveling direction can be straight. During the traveling process, the first sub-sensor unit 1011 located on the front side of the pool cleaning robot 10 monitors the distance between the front side and the edge of the pool (that is, obtains the first distance information).

3. Determine whether the first distance information meets the first condition. As mentioned above, during the forward movement of the pool cleaning robot 10, the distance between its front side and the edge of the pool is continuously shortening. If the distance between the two (i.e., the first distance) is greater than the first predetermined distance, it is considered that the first condition is not met, that is, no obstacle is encountered. Then, repeat step 2 and continue to move forward until the first condition is met. If the distance between the two is less than or equal to the first predetermined distance, it is considered that the first condition is met, that is, an obstacle is encountered. At this time, the pool cleaning robot 10 stops moving, and this location is recorded as the first location.

4. Determine whether to turn right. As mentioned above, the preset path information may include the traveling rules of turning left or right when encountering an obstacle. In this step, the pool cleaning robot 10 can determine whether to turn right according to the preset path information. The first angle of rotation is determined according to the actual situation and is not limited here. If it turns right, then perform the subsequent steps 5-a to 7-a; if it turns left, then perform the subsequent steps 5-b to 7-b.

5-a. The second sensor on the left side obtains the second distance information and travels while keeping the second distance information meeting the second condition. As mentioned above, if it is determined to turn right in step 4, then the second sub-sensor unit 1012 on the left side operates. It measures the second distance between the left side of the pool cleaning robot 10 and the edge of the pool by emitting a sensing signal. In order to make the traveling path of the pool cleaning robot 10 conform to the edge of the pool, it controls the second distance to be maintained within the second predetermined distance range (that is, meeting the second condition) during the traveling.

6-a. Determine whether the third distance meets the third condition. As mentioned above, the pool cleaning robot 10 travels while keeping the second distance meeting the second condition until it stops when it reaches the second location.

Specifically, it can be determined whether the pool cleaning robot 10 has reached the second location by checking if the third distance meets the third condition. If the third distance meets the third condition, then proceed to step 7-a; if the third distance does not meet the third condition, then repeat step 5-a until it is met.

As mentioned above, the third distance is the distance between the first location and the second location in the translation direction perpendicular to the traveling direction. That is to say, the first location can be regarded as the origin, and the traveling direction can be regarded as the y-axis direction. When the distance between the projection of the second location on the x-axis direction and the origin meets the third condition, the pool cleaning robot 10 reaches the second location.

In one embodiment of the present disclosure, the third condition may include that the third distance is equal to the third predetermined distance.

In another embodiment of the present disclosure, the third condition may include that the traveling time between the second location and the first location reaches the preset time.

7-a. Stop and rotate to the right. As mentioned above, the pool cleaning robot 10 reaches the second location and then rotates to the right by a second angle so that it can continue to travel based on the preset path information, for example, continue to move straight forward.

It should be noted that the rotation angle value of the second angle can be a second preset angle value, or it can be determined based on the traveling direction of the path, or it can be determined based on the yaw angle given by the IMU. Specifically, the second angle may also have a certain correlation with the first angle.

5-b. The second sensor on the right side obtains the second distance information and travels while keeping the second distance information meeting the second condition. As mentioned above, if it is determined to turn left in step 4, then the second sub-sensor unit 1012 on the right side operates. It measures the second distance between the right side of the pool cleaning robot 10 and the edge of the pool by emitting a sensing signal. In order to make the traveling path of the pool cleaning robot 10 conform to the edge of the pool, it controls the second distance to be maintained within the second predetermined distance range (that is, meeting the second condition) during the traveling.

6-b. Determine whether the third distance meets the third condition. This step is the same as step 6-a. It can be understood that if the third distance meets the third condition, then proceed to step 7-b; if the third distance does not meet the third condition, then repeat step 5-b until it is met. Details will not be repeated here.

7-b. Stop and rotate to the left. As mentioned above, the pool cleaning robot 10 reaches the second location and then rotates to the left by a second angle so that it can continue to travel based on the preset path information, for example, continue to move straight forward.

It should be noted that the rotation angle value of the second angle can be a second preset angle value, or it can be determined based on the traveling direction of the path, or it can be determined according to the yaw angle provided by the IMU. Specifically, the second angle may also have a certain correlation with the first angle.

8. Continue traveling based on the preset path information. As described above, after rotating by the second angle, the pool cleaning robot 10 returns to the preset path information and continues to travel according to it.

9. Determine whether the preset path information has been completely traversed. If the preset path information has been completely traversed, then the pool cleaning robot 10 ends the cleaning task; if the preset path information has not been completely traversed, then continue to repeat steps 2 to 9 above until it is completed.

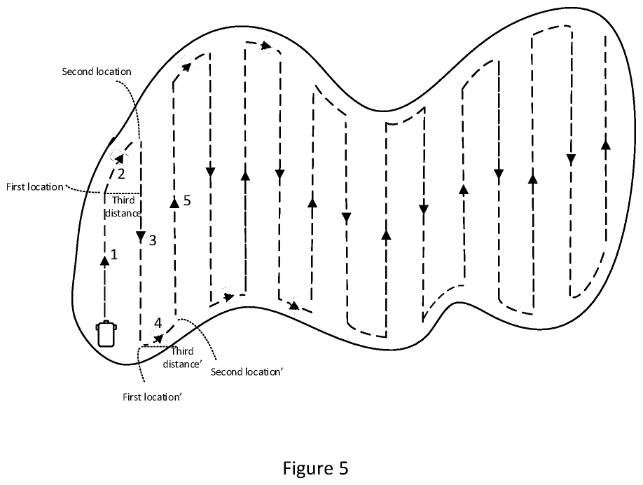

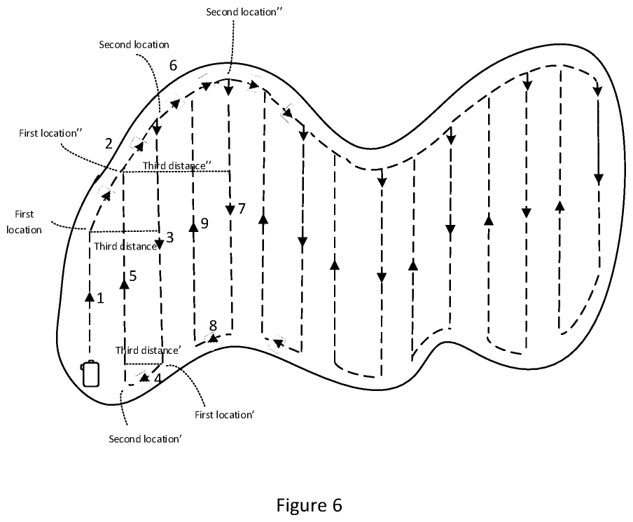

So far, the entire process of the path planning method in the embodiments of the present disclosure has been described. Next, the cleaning paths will be specifically introduced in combination with different types of pool cleaning robots 10. FIG. 5 shows a pool cleaning robot 10 equipped with two second sub-sensor units 1012; FIG. 6 shows a pool cleaning robot 10 equipped with one second sub-sensor unit 1012. The details are as follows.

FIG. 5 is a schematic diagram of the path of the path planning method according to the embodiment of the present disclosure. As shown in FIG. 5, the black solid line in the figure represents the contour of the pool, and the black dotted line represents the cleaning path of the pool cleaning robot 10. In this figure, the pool cleaning robot 10 is equipped with two second sub-sensor units 1012 (that is, the robot shown in (A) of FIG. 2B), which means that it can rotate both to the left and to the right.

5-1. Determine the preset path information based on the contour information of the edge of the pool, the cleaning coverage requirement, or the size information of the pool cleaning robot 10.

The traveling rules can be: move straight, turn right when encountering an obstacle for the first time, then turn right again after traveling a certain distance, continue to move straight, turn left when encountering an obstacle again, then turn left again after traveling a certain distance, and continue to move straight.

5-2. The pool cleaning robot 10 travels and cleans along the preset path 1, and the first sub-sensor unit 1011 on its front side monitors the first distance between it and the edge of the pool.

5-3. When the first distance is equal to or less than the first preset distance, that is, when it reaches the first location, the pool cleaning robot 10 stops traveling.

5-4. Based on the preset path information, since this is the first time encountering an obstacle here, the pool cleaning robot 10 rotates to the right by the first angle so that the sensing signal emitted by the second sub-sensor unit 1012 on its left side can reach the edge of the pool.

5-5. The second sub-sensor unit 1012 on the left side monitors the second distance between it and the edge of the pool, and makes it travel while keeping the second distance within the second predetermined distance range. Its traveling path is shown as path 2 in the figure.

5-6. When the third distance projected in the x-axis direction satisfies the third condition, it reaches the second location.

5-7. The pool cleaning robot 10 stops traveling and rotates to the right by the second angle so that it can continue to move straight based on the preset path 3.

5-8. The pool cleaning robot 10 continues to travel along the preset path information 3.

5-9. Determine whether the preset path information has been completely traversed. If it has been completely traversed, then end; if not, repeat the above process.

5-10. The pool cleaning robot 10 travels and cleans along the preset path 3, and the first sub-sensor unit 1011 on its front side monitors the first distance′ between it and the edge of the pool.

5-11. When the first distance′ is equal to or less than the first preset distance, that is, when it reaches the first location′, the pool cleaning robot 10 stops traveling.

5-12. Based on the preset path information, since this is encountering an obstacle again here, the pool cleaning robot 10 rotates to the left by the first angle′ so that the sensing signal emitted by the second sub-sensor unit 1012 on its right side can reach the edge of the pool.

5-13. The second sub-sensor unit 1012 on the right side monitors the second distance′ between it and the edge of the pool, and makes it travel while keeping the second distance′ within the second predetermined distance range. Its traveling path is shown as path 4 in the figure.

5-14. When the third distance′ projected in the x-axis direction satisfies the third condition, it reaches the second location′.

5-15. The pool cleaning robot 10 stops traveling and rotates to the left by the second angle′ so that it can continue to move straight based on the preset path 5.

5-16. The pool cleaning robot 10 continues to travel along the preset path 5.

5-17. Determine whether the preset path information has been completely traversed. If it has been completely traversed, then end; if not, repeat the above process from 5-2 to 5-17 until it is completed.

It can be understood that, in the case shown in this figure, the length of the third distance that satisfies the third condition is equal to the path spacing in the preset path information.

FIG. 6 is a schematic diagram further illustrating the path of the path planning method according to the embodiment of the present disclosure. As shown in FIG. 6, the black solid line in the figure represents the contour of the pool, and the black dotted line represents the cleaning path of the pool cleaning robot 10. In this figure, the pool cleaning robot 10 is equipped with one second sub-sensor unit 1012 on the left side (that is, the robot shown in (B) of FIG. 2B), which means that it can only rotate to the right.

6-1. Determine the preset path information based on the contour information of the edge of the pool, the cleaning coverage requirement, or the size information of the pool cleaning robot 10.

The traveling rules can be: move straight, turn right when encountering an obstacle, then turn right again after traveling a certain distance, and continue to move straight.

6-2. It is the same as step 5-2, and the details will not be repeated here.

6-3. It is the same as step 5-3.

6-4. Based on the preset path information, since an obstacle is encountered here, the pool cleaning robot 10 rotates to the right by the first angle so that the sensing signal emitted by the second sub-sensor unit 1012 on its left side can reach the edge of the pool.

6-5. It is the same as step 5-5. It should be noted that the length of the traveling path 2 in this figure is different from that of the traveling path 2 in FIG. 5 (the path 2 in this figure is as shown in the path from the first location to the second location).

6-6. It is the same as step 5-6. It should be noted that the second location in this figure is different from the second location in FIG. 5. The length of the third distance that satisfies the third condition in this step is equal to twice the path spacing in the preset path information.

6-7. It is the same as step 5-7. It should be noted that the preset path 3 in this figure is different from the preset path 3 in FIG. 5.

6-8. It is the same as step 5-8.

6-9. Determine whether the preset path information has been completely traversed. If it has been completely traversed, then end; if not, repeat the above process from 6-2 to 6-9.

It should be noted that since the pool cleaning robot 10 in this figure is not equipped with the second sub-sensor unit 1012 on the right side, it can only turn right. This leads to an overlap in its cleaning path, and the judgment standard of the third distance for determining whether the third condition is met each time is not fixed. The details are as follows:
When the pool cleaning robot 10 travels to the first location′, it rotates to the right by the first angle′, and its traveling path is as shown in path 4. The third distance′ between the projection of the first location′ and the second location′ is equal to one time the path spacing. Then the pool cleaning robot 10 continues to travel. The path from the first location″ to the second location″ is as shown in path 6. Path 6 partially overlaps with path 2, and the projected third distance″ is three times the path spacing.

It can be understood that, in the case shown in this figure, the third distance that satisfies the third condition can be an integer multiple of the path spacing in the preset path information.

It should be noted that the case where the second sub-sensor unit 1012 is only configured on the right side is not shown. The principle is the same as that in FIG. 6, and the details will not be repeated here.

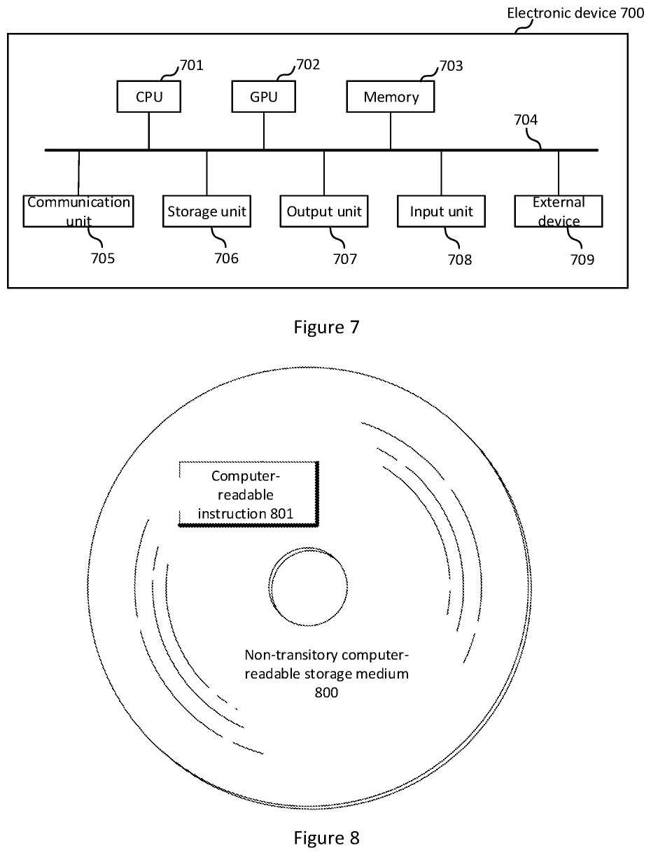

FIG. 7 is a hardware block diagram of an electronic device 700 according to an embodiment of the present disclosure. The electronic device according to an embodiment of the present disclosure at least includes a processor; and a memory for storing computer-readable instructions. When the computer-readable instructions are loaded and run by the processor, the processor executes the path planning method as described above.

Specifically, the electronic device 700 shown in FIG. 7 includes a central processing unit (CPU) 701, a graphics processing unit (GPU) 702, and a memory 703. These units are interconnected via a bus 704. The central processing unit (CPU) 701 and/or the graphics processing unit (GPU) 702 can be used as the above-mentioned processor, and the memory 703 can be used as the memory for storing the above-mentioned computer-readable instructions. In addition, the electronic device 700 may further include a communication unit 705, a storage unit 706, an output unit 707, an input unit 708, and external devices 709, and these units are also connected to the bus 704.

FIG. 8 is a schematic diagram of a non-transitory computer-readable storage medium according to an embodiment of the present disclosure. As shown in FIG. 8, a non-transitory computer-readable storage medium 800 according to an embodiment of the present disclosure has computer-readable instructions 801 stored thereon. When the computer-readable instructions 801 are executed by a processor, the path planning method described with reference to the above drawings is executed. The non-transitory computer-readable storage medium includes but is not limited to, for example, volatile memory and/or non-volatile memory. The volatile memory may include, for example, random access memory (RAM) and/or a cache memory, etc. The non-volatile memory may include, for example, read-only memory (ROM), a hard disk, a flash memory, an optical disc, a magnetic disk, etc.

Above, the path planning method, the pool cleaning robot, and the non-transitory computer-readable storage medium according to the embodiments of the present disclosure have been described with reference to the drawings. According to the path planning method of the embodiments of the present disclosure, by configuring sensors to perceive the distance from the edge of the pool, the cleaning path can be made to conform to the edge of the pool, thereby improving the cleaning coverage rate and cleaning efficiency.

A person of ordinary skill in the art can understand that the units and algorithm steps of the various examples described in conjunction with the embodiments disclosed herein can be implemented either by electronic hardware or by a combination of computer software and electronic hardware. Whether these functions are executed in a hardware or software manner depends on the specific application and design constraints of the technical solution. Professional technicians can use different methods for each specific application to implement the described functions, but such implementations should not be considered as going beyond the scope of the present disclosure.

The basic principles of the present disclosure have been described above in combination with specific embodiments. However, it should be noted that the advantages, benefits, and effects mentioned in the present disclosure are merely examples rather than limitations, and it cannot be considered that these advantages, benefits, and effects are essential for each embodiment of the present disclosure. In addition, the specific details disclosed above are only for illustrative purposes and to facilitate understanding, rather than being limitations. These details do not restrict the present disclosure to being implemented using the specific details described above.

The block diagrams of the devices, apparatuses, equipment, and systems involved in the present disclosure are merely exemplary and are not intended to require or imply that they must be connected, arranged, and configured in the manner shown in the block diagrams. As those skilled in the art will recognize, these devices, apparatuses, equipment, and systems can be connected, arranged, and configured in any way. Words such as “include,” “comprise,” and “have” are open-ended terms, meaning “including but not limited to,” and can be used interchangeably. The words “or” and “and” used here refer to the term “and/or” and can be used interchangeably with it, unless the context clearly indicates otherwise. The word “such as” used here refers to the phrase “such as but not limited to” and can be used interchangeably with it.

In addition, as used herein, the “or” used in the enumeration of items starting with “at least one” indicates a separate enumeration. For example, the enumeration of “at least one of A, B, or C” means A or B or C, or AB or AC or BC, or ABC (i.e., A and B and C). Furthermore, the term “exemplary” does not mean that the described example is preferred or better than other examples.

It should also be pointed out that in the systems and methods of the present disclosure, each component or each step can be decomposed and/or recombined. These decompositions and/or recombination should be regarded as equivalent solutions of the present disclosure.

Various changes, substitutions, and alterations to the technologies described herein can be made without departing from the teachings defined by the appended claims. In addition, the scope of the claims of the present disclosure is not limited to the specific aspects of the processes, machines, manufactures, compositions of events, means, methods, and acts described above. Processes, machines, manufactures, compositions of events, means, methods, or acts that currently exist or will be developed later can be utilized to perform functions that are substantially the same as the corresponding aspects described herein or to achieve substantially the same results. Therefore, the appended claims cover such processes, machines, manufactures, compositions of events, means, methods, or acts within their scope.

The above description of the disclosed aspects is provided to enable any person skilled in the art to make or use the present disclosure. Various modifications to these aspects are quite obvious to those skilled in the art, and the general principles defined herein can be applied to other aspects without departing from the scope of the present disclosure. Therefore, the present disclosure is not intended to be limited to the aspects shown herein, but should be accorded the broadest scope consistent with the principles and novel features disclosed herein.

The above description has been given for the purposes of illustration and description. Moreover, this description is not intended to limit the embodiments of the present disclosure to the forms disclosed herein. Although multiple example aspects and embodiments have been discussed above, those skilled in the art will recognize certain variations, modifications, changes, additions, and sub-combinations thereof.

1. A path planning method applied to a pool cleaning robot with a first sub-sensor unit configured on a first side of the pool cleaning robot and at least one second sub-sensor unit configured on a second side of the pool cleaning robot, comprising:
obtaining first distance information via the first sub-sensor unit, wherein the first distance information indicates a first distance between the first side of the pool cleaning robot and an edge of the pool;
when the first distance information meets a first condition, controlling the pool cleaning robot at a first location to rotate by a first angle, wherein the first angle enables a sensing signal emitted by the at least one second sub-sensor unit to reach the edge of the pool, and the first angle is determined based on a sensing result of the at least one second sub-sensor unit;
obtaining second distance information via the at least one second sub-sensor unit, wherein the second distance information indicates a second distance between the second side of the pool cleaning robot and the edge of the pool; and
controlling the pool cleaning robot to travel to a second location while keeping the second distance information meeting a second condition.

2. The path planning method according to claim 1, further comprising:
determining preset path information based on contour information of the edge of the pool, cleaning coverage requirement, or size information of the pool cleaning robot, wherein the preset path information comprises at least one of the following: traveling rules, a traveling direction, a path spacing, and a traveling sequence of paths of the pool cleaning robot.

3. The path planning method according to claim 2, wherein the first distance information indicates the first distance between the first side and the edge of the pool in the traveling direction based on the preset path information.

4. The path planning method according to claim 3, wherein a third distance between the first location and the second location in a translation direction perpendicular to the traveling direction meets a third condition.

5. The path planning method according to claim 4, wherein the first condition comprises that the first distance is less than or equal to a first predetermined distance, the second condition comprises that the second distance is within a second predetermined distance range, and the third condition comprises that the third distance is equal to a third predetermined distance or the traveling duration between the second location and the first location reaches a preset duration.

6. The path planning method according to claim 5, wherein the third predetermined distance comprises an integer multiple of the path spacing.

7. The path planning method according to claim 2, further comprising:
controlling the pool cleaning robot at the second location to rotate by a second angle and continue to travel based on the preset path information.

8. (canceled)

9. (canceled)

10. The path planning method according to claim 7, wherein the second angle comprises a second preset angle value, or the second angle is determined based on the traveling direction of the path or based on a yaw angle given by an inertial measurement unit.

11. A pool cleaning robot, comprising:
a sensor unit, configured to comprise a first sub-sensor unit configured on a first side of the pool cleaning robot and at least one second sub-sensor unit configured on a second side of the pool cleaning robot, wherein the first sub-sensor unit is configured to obtain first distance information and the at least one second sub-sensor unit is configured to obtain second distance information, the first distance information indicates a first distance between the first side of the pool cleaning robot and an edge of a pool, and the second distance information indicates a second distance between the second side of the pool cleaning robot and the edge of the pool;
a control unit, configured to, when the first distance information meets a first condition, control the pool cleaning robot at a first location to rotate by a first angle, wherein the first angle enables at least a sensing signal emitted by the at least one second sub-sensor unit to reach the edge of the pool, and the first angle is determined based on a sensing result of the at least one second sub-sensor unit; and control the pool cleaning robot to travel to a second location while keeping the second distance information meeting a second condition.

12. (canceled)

13. The pool cleaning robot according to claim 11, wherein the first side comprises a front side, and the second side comprises a left side or a right side.

14. The pool cleaning robot according to claim 11, wherein the control unit determines preset path information based on contour information of the edge of the pool, cleaning coverage requirement, or size information of the pool cleaning robot, wherein the preset path information comprises at least one of the following: traveling rules, a traveling direction, a path spacing, and a traveling sequence of the paths of the pool cleaning robot.

15. The pool cleaning robot according to claim 14, wherein the first distance information indicates the first distance between the first side and the edge of the pool in the traveling direction based on the preset path information.

16. The pool cleaning robot according to claim 15, wherein a third distance between the first location and the second location in a translation direction perpendicular to the traveling direction meets a third condition.

17. The pool cleaning robot according to claim 16, wherein the first condition comprises that the first distance is less than or equal to a first predetermined distance, the second condition comprises that the second distance is within a second predetermined distance range, and the third condition comprises that the third distance is equal to a third predetermined distance or a walking duration between the second location and the first location reaches a preset duration.

18. The pool cleaning robot according to claim 17, wherein the third predetermined distance comprises an integer multiple of the path spacing.

19. (canceled)

20. A non-transitory computer-readable storage medium having computer-readable instructions stored thereon, wherein the computer-readable instructions cause a processor to perform the path planning method according to claim 1.
